(19) United States
(12) Patent Application Publication
(10) Pub. No.: US 2010/0019418 A1
(43) Pub. Date: Jan. 28, 2010

(54) METHOD FOR MANUFACTURING A REVOLVING SHAFT ASSEMBLY

(75) Inventor: CHUEN-SHU HOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/177,847

(22) Filed: Jul. 22, 2008

(51) Int. Cl. C04B 35/64

(52) U.S. Cl. 264/643

(57) ABSTRACT

A method for manufacturing a revolving shaft assembly includes the steps of: 1) offering a plurality of first nonmetallic powder; 2) offering a plurality of second nonmetallic powder; 3) offering a mold cavity and filling the first and second nonmetallic powder in the mold cavity to form a green piece, wherein a plurality of pores is defined in the green piece; 4) heating the green piece at a temperature between 1100° C. and 1550° C. to sinter the nonmetallic powder to obtain a sintered product; 5) dipping the sintered product in lubricant oil to make the lubricant oil enter the pores of the sintered product to thereby obtain a final desired product.

### BACKGROUND OF THE INVENTION

1. Field of the Invention

The present invention relates to a method for manufacturing a revolving shaft assembly, and more particularly to a method for manufacturing a nonmetallic revolving shaft assembly with high hardness and abrasion resistance.

2. Description of Related Art

Generally, a revolving shaft assembly is used as a hinge in electronic devices, such as notebook, mobile phone, media player and so on. The revolving shaft assembly includes a driving member and a driven member interfereferingly and pivotally engaging with the driving member. The driving member and the driven member are made of metallic material such as steel or alloyed steel. The driving member and the driven member have lower hardness, so a serious abrasion occurs between the driving member and the driven member after a period of use of the shaft assembly. The function and the lifespan of the revolving shaft assembly are accordingly affected and shortened.

It is therefore desirable to provide a method for manufacturing an improved revolving shaft assembly with a driving member and a driven member which have high hardness and abrasion resistance to avoid being unduly worn.

### SUMMARY OF THE INVENTION

A method for manufacturing a revolving shaft assembly includes the steps of: 1) offering a plurality of first nonmetallic powder; 2) offering a plurality of second nonmetallic powder; 3) offering a mold cavity and filling the first and second nonmetallic powder in the mold cavity to form a green piece, wherein a plurality of pores is defined between the nonmetallic powder of the green piece; 4) heating the green piece at a temperature between 1100° C. and 1500° C. to sinter the nonmetallic powder to obtain a sintered product; 5) dipping the sintered product in lubricant oil to make the lubricant oil enter the pores of the sintered product to thereby obtain a final desired product.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled view of a revolving shaft assembly in accordance with a first embodiment of the present invention;

FIG. 2 is an exploded view of FIG. 1; and

FIG. 3 is an inverted view of FIG. 2.

### DETAILED DESCRIPTION OF THE INVENTION

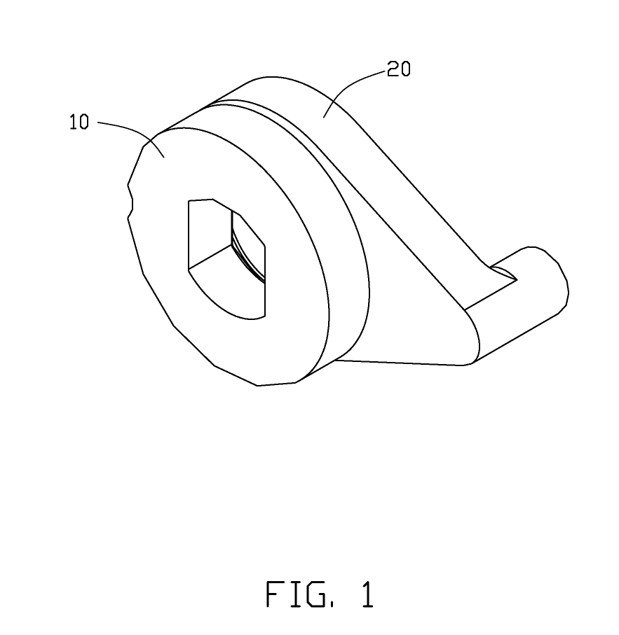

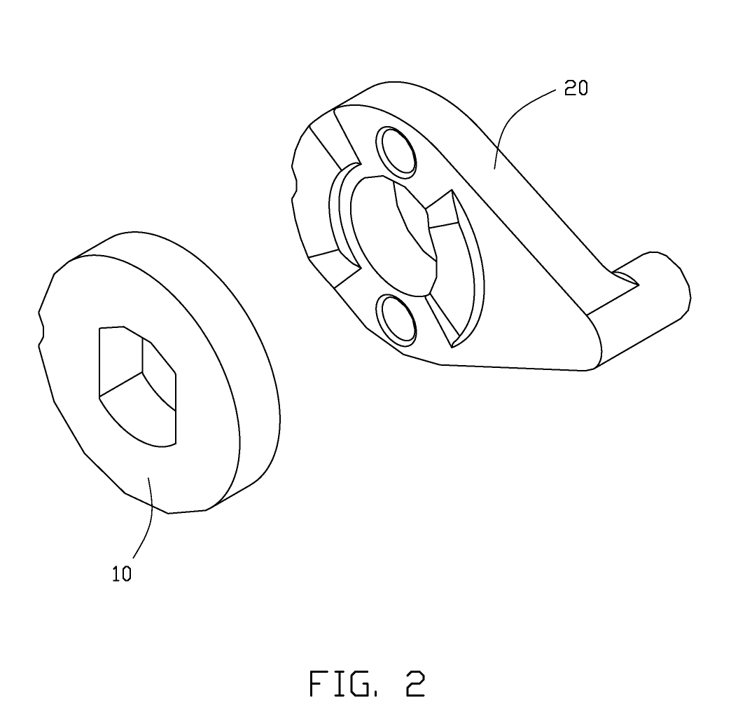

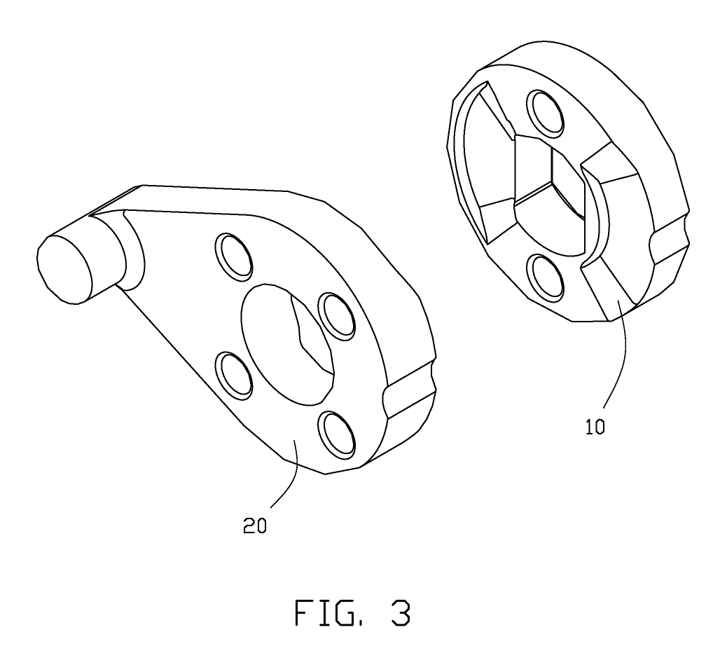

Referring to FIGS. 1-3, a revolving shaft assembly comprises a driving member 10 and a driven member 20 pivotally engaging with the driving member 10. The driving and driven members 10, 20 are provided with a shaft (not shown) extending therethrough in series. The driving member 10 rotates with the shaft synchronously. The driven member 20 is fixed to a main bracket (not shown). Each of the driving member 10 and the driven member 20 has an inner surface (not labeled) oriented towards each other. The inner surfaces of the driving member 10 and the driven member 20 intimately engage with each other. The driving member 10 and the driven member 20 can be rotated relative to each other.

A method for manufacturing the revolving shaft assembly in accordance with a first embodiment of the present invention comprises the steps of: 1) offering a quantity of ZrO₂ powder as a first nonmetallic powder; 2) offering a quantity of Y₂O₃ powder as a second nonmetallic powder; 3) mixing the ZrO₂ powder and the Y₂O₃ powder to have mixed powder; 4) offering a mold (not shown) having a cavity and filling the mixed powder into the cavity of the mold and pressing the mixed powder to make a green piece, wherein pores (not shown) are defined between the pressed mixed powder and a volume ratio of the pores of the green piece is situated between 30% and 50%, and a volume ratio between 35% and 40% of the pores in the green piece is preferable; 5) heating the green piece at a temperature between 1100° C. and 1500° C., whereby the mixed powder of the green piece is sintered and diffusion bonded together to obtained a sintered product, wherein a volume ratio of pores of the sintered product is situated between 1.5% and 6%, and a hardness value of the sintered product is situated between 900 HV and 1300 HV, and a toughness value of the sintered product is situated between 6K1c and 12K1c; 6) post-treating the inner surfaces of the driving member 10 and the driven member 20 to obtain surface roughness value less than Ra0.1 μm for the driving member 10 and the driven member 20; 7) dipping the sintered product into lubricant oil to fill the lubricant oil in the pores of the sintered product thereby to obtain a final desired product for forming the revolving shaft assembly.

In this embodiment, the Y₂O₃ powder acting as an additive is added to the ZrO₂ powder to improve the hardness and toughness of the ZrO₂ powder. The Y₂O₃ powder accounts for 3%-15% of the revolving shaft assembly by weight. The driving member 10 and the driven member 20 have high hardness and abrasion resistance. When the driving member 10 and the driven member 20 are assembled together, inner surfaces of the driving member 10 and the driven member 20 are intimately engaged with each other. An lubricant oil film is formed between the inner surfaces of the driving member 10 and the driven member 20 to lubricate the revolving shaft assembly. Thus, the driving member 10 and the driven member 20 can rotate smoothly relative to each other and avoid being unduly worn after a period of use thereof.

A method for manufacturing the revolving shaft assembly in accordance with a second embodiment is similar to the first embodiment. A difference between the first and second embodiments is that the second embodiment offers a quantity of Al₂O₃ powder and Y₂O₃ powder as a second powder. The Y₂O₃ powder accounts for 3%-15% of the revolving shaft assembly by weight. The Al₂O₃ powder accounts for 0.1%-0.3% of the revolving shaft assembly by weight. A hardness value of the sintered production in this embodiment is situated between 1100 HV and 1450 HV, and a toughness value of the sintered product is situated between 7K1c and 14K1c.

A method for manufacturing the revolving shaft assembly in accordance with a third embodiment is similar to the first embodiment. A difference between the first and third embodiments is that the third embodiment offers a quantity of carbide powder as the first powder, and a quantity of Si powder and Y₂O₃ powder as a second powder. A quantity of SiC powder or WC powder or Tic powder acts as the first powder. The Y₂O₃ powder accounts for 3%-15% of the revolving shaft assembly by weight. The Si powder accounts for 0.1%-0.3% of the revolving shaft assembly by weight. A hardness value of the sintered production in this embodiment is situated between 2000 HV and 2500 HV. A volume ratio of pores of the sintered product is situated between 0.8% and 5%.

A method for manufacturing the revolving shaft assembly in accordance with a fourth embodiment is similar to the first embodiment. A difference between the first and fourth embodiments is that the fourth embodiment offers a quantity of BN powder and Y₂O₃ powder as a second powder. The Y₂O₃ powder accounts for 3%-15% of the revolving shaft assembly by weight. The BN powder accounts for 0.1%-0.3% of the revolving shaft assembly by weight. The friction coefficient of the revolving shaft assembly is small because of the BN powder; thus, the abrasion between the driving member 10 and the driven member 20 is reduced.

The oxide additive, which accounts for 3%-15% of the revolving shaft assembly by weight, of the above-mentioned four embodiments may be CeO₂ powder or MgO powder or CaO powder.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A method for manufacturing a revolving shaft assembly, comprising the steps of:
1) offering a quantity of first nonmetallic powder, which is ZrO₂ powder;
2) offering a quantity of second nonmetallic powder, which is composed of one of Y₂O₃ powder, CeO₂ powder, MgO powder and CaO powder and accounts for 3%˜15% of the revolving shaft assembly by weight;
3) offering a mold cavity and filling the first and second nonmetallic powders in the mold cavity to form a green piece, wherein a plurality of pores is defined between the nonmetallic powders of the green piece;
4) heating the green piece at a temperature between 1100° C. and 1550° C. to sinter the nonmetallic powders to obtain a sintered product; and
5) dipping the sintered product in lubricant oil to make the lubricant oil enter the pores of the sintered product to thereby obtain a final desired product.

2-5. (canceled)

6. The method for manufacturing a revolving shaft assembly as in claim 1, wherein a volume ratio of pores of the revolving shaft assembly is situated between 1.5% and 6% .

7-12. (canceled)

13. A method for manufacturing a revolving shaft assembly, comprising the steps of:
1) offering a quantity of first nonmetallic powder, which is one of SiC powder, WC powder and TiC powder;
2) offering a quantity of second nonmetallic powder, which is a mixture composed of a quantity of oxide power and Si powder, the oxide powder accounting for 3%˜15% of the revolving shaft assembly by weight, the Si powder accounting for 0.1%˜0.3% of the revolving shaft assembly by weight;
3) offering a mold cavity and filling the first and second nonmetallic powders in the mold cavity to form a green piece, wherein a plurality of pores is defined between the nonmetallic powders of the green piece;
4) heating the green piece at a temperature between 1100° C. and 1550° C. to sinter the nonmetallic powder to obtain a sintered product; and
5) dipping the sintered product in lubricant oil to make the lubricant oil enter the pores of the sintered product to thereby obtain a final desired product.

14. The method for manufacturing a revolving shaft assembly as in claim 13, wherein the oxide powder is one of Y₂O₃ powder, CeO₂ powder, MgO powder, and CaG powder.

15. The method for manufacturing a revolving shaft assembly as in claim 13, wherein a volume ratio of pores of the revolving shaft assembly is situated between 0.8% and 5%.
